(19) United States
(12) Patent Application Publication
(10) Pub. No.: US 2008/0222267 A1
(43) Pub. Date: Sep. 11, 2008

(54) METHOD AND SYSTEM FOR WEB CLUSTER SERVER

(76) Inventor: Ray C. Horn, Vallejo, CA (US)

Correspondence Address: Daniel L. Flamm, 476 Green View Dr., Walnut Creek, CA, 94596-5459, US

(21) Appl. No.: 11/684,511

(22) Filed: Mar. 9, 2007

(51) Int. Cl. G06F 15/16

(52) U.S. Cl. 709/217

(57) ABSTRACT

A method is provided for balancing the load from clients sending requests to a cluster server for an internet domain. The cluster server has a domain manager for redirecting traffic for the domain. The method includes receiving a request from a client in the domain manager. The domain manager selects a client server for servicing the request, and a message is sent to the client for redirecting the request to the selected client server, without user interaction. The method also includes a cluster server with geographically distributed subordinate clusters.

### FIELD OF THE INVENTION

The present invention relates generally to a cluster system for serving content of a domain to clients, and more particularly relates to balancing a load over multiple servers.

### BACKGROUND OF THE INVENTION

World Wide Web domain servers send a wide variety of information and services over the internet to diverse geographical areas at low cost. All of the principal Web platform technologies such as Linux, Apache, MySQL, Perl, Python, PHP, Microsoft ASP and ASP.NET, and JSP (Java Server Pages) deliver content over the web using the HTTP protocol (Hypertext Transfer Protocol). A common problem is that the performance of Web domain servers generally degrades as an increasing number of users attempt to access a domain. This degradation is often manifest in costly delays (latency) which result in lost revenue during the time when a site is unavailable.

Performance degradation is caused by a number of effects. One factor is a limitation on the capacity of the data path to carry information between the user's client and the server. As more users seek access to a server, one or more segments of a network channel between the server and internet can approach saturation, resulting in increased latency. On the other hand, the server's capacity for processing multiple incoming requests from web browser clients is limited and processing limitations can result in annoying or unacceptable latency between a client request and the server response. Under various circumstances, the latency between a client request and the server response can be also be limited by the time for data to propagate over the internet. Data sent over the internet often traverses numerous routers, servers and media, all of which impose delays. Internet latency tends to be greater when the client and web server are separated by large distances.

Reliability and scalability are also important considerations for domain cluster servers. Since downtime is often costly, there is a need for domain cluster servers that operate without interruption when a physical server fails. Incremental increases in the server capability are often needed as business grows and the traffic to a domain increases. Hence there is a need for expansion and redundancy at relatively low cost.

Domain server performance can be improved by provisioning a multiplicity of physical servers to receive and/or process traffic between clients and a domain. However this has been relatively difficult or costly to effectuate in practice. One simple method for load sharing among multiple physical servers is to associate the domain name with the IP addresses of the servers in authoritative domain name servers (DNS). Ideally this would result in client requests being directed to the alternate IP addresses of different physical servers in a round robin manner. However this method does not work well in practice because DNS requests are often filled with stored data from a network cache to avoid excessive latency.

In some load balancing technologies, client service requests to a domain are directed to a single IP address of a gateway device. Conventional gateway devices often comprise specialized routing hardware and/or software which intercept transport layer packets and rewrite the packet header addresses for sending to a physical server. Requests received by the gateway are forwarded to a physical server for processing. These gateways have been relatively costly and the associated software configuration is often complex and difficult to maintain.

Load balancing systems and software have also been limited in their ability to diagnose and correct latency. Conventional devices and methods often distribute traffic based on the physical resources installed in a cluster rather than on current server utilization and/or task requirements. As pointed out, load balancing has often been performed by network hardware and/or software at the network transport level. However the transport packets merely convey an application layer payload. These methods make relatively little or no use of information concerning the applications and/or processing resources that are required to service application layer requests. Furthermore, conventional systems often manage client requests by sending them to the physical servers “round robin,” or by distributing the load based on the numbers of packets in a request. Individual server capability, the type of application service request, and/or the actual load on a physical server are often neglected.

Other conventional load balancing systems depend on having physical servers dedicated to certain applications. For example, in some conventional systems, database service queries are routed to database servers; multimedia requests are routed to multimedia servers, and so forth. Such dedicated servers are underutilized at times when demand for the hosted application is relatively low. When the peak load for a dedicated server grows to maximum capacity, costly equipment is often duplicated or replaced in order to accommodate relatively small further increases in demand. Hence having sufficient dedicated server capacity to meet peak demand is often expensive and inefficient.

Accordingly, there is a need for low cost cluster server load balancing methods, systems and equipment that efficiently allocate resources to service client requests. Moreover, there is a need for simple and economical domain cluster server hardware, and methods to select physical servers for low latency. Furthermore, there is a need for domain cluster servers that can be expanded in relatively low cost increments as domain traffic increases.

### SUMMARY

One aspect of the invention has a method for providing information to a client. The method comprises receiving a first request from the client in a first manager of a cluster server for a domain. A first client server of the cluster server is selected for the first request with no user interaction, and a first message is sent from the first manager to the client. The first message comprises redirection of the first request to the selected first client server. A redirected first request from the client is received in the selected first client server and a second message is sent to the client from the selected first client server. The first request and the redirected first request each comprises a request for the information. Furthermore, the second message sent to the client is a message responsive to the redirected first request. The cluster server comprises two or more client servers and one or more managers.

There are aspects where the first request and the redirected first request are HTTP GET requests, and the first and second messages are HTTP messages. Furthermore, in various aspects, the second message sent to the client comprises the information. In one aspect, the first manager is a domain manager or a subordinate cluster manager. In another aspect, selecting a client server is based on a latency method. In a further aspect, selecting a client server is based on a round robin method. Also, the redirection comprises a unique prefix to a URL of the domain in yet another aspect.

In other aspects, the method further comprises obtaining first data from a database with a first database server, and receiving the first data from the first database server in a first module. In these other aspects the cluster server further comprises the database and one or more database servers. The first database server is selected from among the one or more database servers, and the first module is a manager or a client server of the cluster server. In a related aspects the method further comprises sending second data relating to the client from a second module to a second database server, storing the second data in the database with the second database server, obtaining the second data from the database with the first database server, and receiving the second data from the first database server in the first module. The second database server is selected from among any of the one or more database servers, and the second module is a manager or a client server of the cluster server. The second data comprises a session identification descriptor in some embodiments. Obtaining the second data from the database depends on a session identification descriptor in further embodiments. In a further aspect, the second module receives at least a portion of the second data from the client.

In additional aspects, a physical unit having no client server comprises the database and for each module of the two or more client servers and one or more managers of the cluster server, there is at least one database server among the one or more database servers of the cluster server that is operable to communicate with the module over a communications channel. In another aspect, none of the database servers are accessible to any unit outside of the cluster server in aspects.

In another aspect, the cluster server further comprises at least first and second subordinate clusters having respective first and second subordinate cluster managers. Selecting the first client server in this aspect comprises selecting a subordinate cluster manager from among the subordinate cluster managers of the cluster server. In a related aspect, selecting the subordinate cluster manager depends on the geographic location of the client

In a different aspect of the method for providing information to a client, the cluster server further comprises at least one subordinate cluster server having one subordinate cluster manager. Also in this different aspect, the method further comprises receiving another request from the client, in a domain manager of the cluster server, and selecting a subordinate cluster manager of the cluster server for the other request with no user interaction. As well, the method further comprises sending another message from the domain manager to the client in this aspect. The other message comprises redirection of the other request to the selected subordinate cluster manager. Finally in this different aspect, the method further comprises receiving a redirected other request from the client in the selected subordinate cluster manager. In a dependent aspect, the first request from the client is the redirected other request received in the selected subordinate cluster manager, and the selected subordinate cluster manager is the first manager.

In an additional aspect of the method for providing information to a client, the cluster server comprises at least first and second subordinate clusters and a database. The first subordinate cluster comprises a first database server and the second subordinate cluster comprises a second database server. The database is mirrored in at least the first and second database servers. Furthermore, at least one module sends data that relates to the client, to the first database server for storing in the database. The first database server stores the data relating to the client in the database. Another module receives the data relating to the client, from a selected database server. The selection is from among the first and the second database servers. The one module and other module each are a manager or a client server of the cluster server.

In a still further aspect of the method for providing information to a client, the cluster server further comprises at least one database server and a database, the database server obtains at least a portion of the information from the database, the selected client server receives that portion of the information from the database server, and the second message to the client comprises that portion of the information.

Another aspect of the invention is a cluster server. The cluster server comprises a traffic redirector, two or more client servers, a database, and one or more database servers. The traffic redirector is operable to receive a first request for content from a client, to select a first client server from among the two or more client servers to send the content to the client, and to send a message to the client to redirect the first request for content to the selected first client server. Each of at least two client servers from among the two or more client servers is operable to send the content to the client responsive to receiving a redirected first request for content from the client. Also, at least one database server from among the one or more database servers is operable to obtain at least a portion of the content from the database and send that portion of the content to the selected client server.

There is an aspect of the cluster server where the traffic director is operable to send first data to, and receive second data from, a first database server selected from among all of the one or more database servers. Also, the first client server is operable to send second data to and receive first data from a second database server selected from among all of the one or more database servers. Furthermore, another client server selected from among all of the one or more client servers is operable to receive the first or the second data from a third database server selected from among all of the one or more database servers. The first or the second data, in single or in combination, relate to the client.

There is another aspect of the cluster server where wherein the first request for content and the redirected first request for content are HTTP GET requests, the message to the client to redirect the first request for content is an HTTP message, and each of the at least two client servers is operable to send the content to the client in an HTTP message.

Another aspect of the invention is readable media. The readable media comprise data and instructions. There are data and instructions are operable for receiving a first request from a client in a manager of a cluster server, and selecting a client server of the cluster server for the first request, without user interaction. There are also data and instructions operable for sending a first message from the manager to the client for redirection of the first request to the selected client server, and receiving a redirected first request from the client in the selected client server. As well, there are data and instructions for sending a second message to the client from the selected client server. In this aspect the first request and the redirected first request each comprises a request for content, and the second message sent to the client comprises the content responsive to the redirected first request.

There is an aspect of the machine readable where the first request and the redirected first request are HTTP GET requests for the content and the first and the second messages to the client are HTTP messages. There is another aspect of the machine readable media further comprising data and instructions operable for sending data relating to the client from a first module in a first physical unit of the cluster server to a database server of the cluster server, storing the data in a database with the database server, and receiving the stored data from the database server in a second module of a second physical unit of the cluster server. In this other aspect each of the first and second modules is a manager or client server.

### BRIEF DESCRIPTION OF DRAWINGS

The present disclosure is illustrated in an exemplary manner by the accompanying drawings. The drawings and accompanying description should be understood to explain principles of the various embodiments rather than be limiting. Other embodiments will become apparent from the description and the following drawings:

FIG. 1A is a diagram showing a cluster server embodiment having a domain manager, two client servers, and one database server;

FIG. 1B is a diagram showing another cluster server embodiment having a domain manager, three client servers, and one database server;

FIG. 2 is a simplified flow chart showing selected steps for sending content to a browser according to an aspect of the disclosure;

FIG. 3 is a diagram of another cluster server embodiment;

FIG. 4 is a diagram showing a further embodiment of a cluster server having a domain manager and two subordinate clusters with subordinate cluster client servers; and

FIG. 5 is a diagram showing various communications channels of an embodiment after FIG. 4.

### DETAILED DESCRIPTION

The present disclosure is directed to systems, methods and equipment for providing information and services over a network. The specific embodiments described in this document are for explaining the systems, methods and equipment. As such they are representative and illustrative in nature rather than restrictive.

In one embodiment, a method is provided for balancing the load from clients sending requests to an internet domain. The method includes receiving a GET request in a domain manager and redirecting the GET request to a client server within a cluster of computers associated with the domain without user interaction. The method also includes selecting a client server to service the GET command. An aspect of the method further includes retrieving information from a database for responding to a request for content from a client. Still further, the method includes storing information related to the client in the database and retrieving the stored information from the database for processing a client request.

In another embodiment a cluster server is presented. The cluster server includes an internet domain server comprising a domain manager for redirecting traffic into the domain, client servers for serving messages responsive to client requests, and a database server comprising a database. The database server is accessible to the domain manager and client servers of the cluster, but inaccessible to any unit outside of the cluster server, such as clients, hardware devices, various nodes, control circuits, and the like on an external network.

In still further embodiments a system comprising a domain manager, subordinate cluster managers, and multiple subordinate clusters of the domain is presented. Managers such as domain managers and subordinate cluster managers are traffic redirectors. The domain manager is to redirect a client GET request to the domain to a selected subordinate cluster. Each of the subordinate clusters has a subordinate cluster manager. The subordinate cluster manager is to redirect a GET request to a client server of its subordinate cluster. In some of the embodiments, subordinate clusters are situated in diverse geographic locations. The diverse geographic locations are to decrease latency in various embodiments. In further embodiments, diverse geographic locations are to reduce network traffic, and/or enhance system reliability.

In one aspect of the invention, a method and apparatus are provided for balancing the load from clients sending requests for content to an internet domain. The internet domain is hosted on an internet domain server. The internet domain server comprises a cluster server. The cluster server has a domain manager, client servers, and at least one database server. In various aspects, a plurality of managers and servers are in a physical unit. For example, in some embodiments, a domain manager and a client server are in one physical unit.

The present teachings may be embodied in various different forms and should not be construed as being limited to the specific embodiments set forth herein. Rather, the embodiments below are provided for illustrative purposes to those having ordinary skill in the art.

The terminology herein is for the purpose of describing particular embodiments and is not intended to be limiting of the invention. It will be understood that, although the terms first, second, etc. may be used to describe various elements, these terms are only used to distinguish one element from another and the elements should not be limited by these terms. For example, a first element could be termed a second element, and similarly a second element could be termed a first element, without departing from the scope of the instant description. As used herein, the singular forms “a”, “an” and “the” are intended to include the plural forms as well, unless the context clearly indicates otherwise. It will be further understood that the terms “comprises,” “comprising,” “includes,” and/or “including” signify the presence of stated features, integers, steps, operations, elements, and/or components, but do not preclude the presence or addition of one or more other features, integers, steps, operations, elements, components, and/or groups thereof. Reference in the specification to “one embodiment”, “an embodiment”, or some embodiment, etc. means that a particular feature, structure, or characteristic described in connection with the embodiment is included in at least one embodiment. The appearances of the phrase “in one embodiment” in various places in the specification are not necessarily all referring to the same embodiment, nor are separate or alternative embodiments mutually exclusive of other embodiments

To clarify certain concepts used in this application, it will be convenient to introduce some definitions. The term communications channel refers to a path, link, or connection through which information passes between various modules. A module refers to a distinct unit that is operable to perform an identifiable function. A module can be a self-contained physical unit or piece of equipment, or a logical component effectuated by a processor and tangible media having instructions and/or data that are operable for the processor to perform the identifiable function. Various types of modules include domain managers, client servers, database servers, subordinate cluster manager modules, and/or clients. A physical module refers to a physical unit consisting essentially of means to perform the module function. For example, a physical DM often consists essentially of media with instructions and data operable to perform the functions of a DM, a processor that is operable perform the instructions and operate on the data, and various support hardware.

A communications channel can be a physical link such as a cable connecting two physical units, electromagnetic signals on frequencies in the electromagnetic spectrum, a protocol layer in a computer networking hierarchy, and/or similar means. The term secure communications channel refers to a communications channel that is secure against eavesdropping. Some secure communications channels are protected against eavesdropping by confining the channel within a secure physical location. However there are also physical and/or virtual communications channels that are secured with an encryption protocol. Some encrypted secure communications channels are carried over a public network such as the internet.

In the following description, for purposes of explanation, numerous specific details are set forth in order to provide a thorough understanding of the various principles. It will be apparent, however, to one skilled in the art, that the principles can be practiced without these specific details. In other instances, structures and devices are shown in simplified form in order to avoid obscuring the concepts.

To facilitate explanation of the invention a single exemplary HTTP client is shown in the various figures and diagrams of the written description. It will be understood that the appearance of one HTTP client connected to a network does not mean that there is only one HTTP client connected to that network or that only HTTP clients are connected to any particular network. Those of ordinary skill in the art will recognize that many different clients often access a network and that clients often use various protocols.

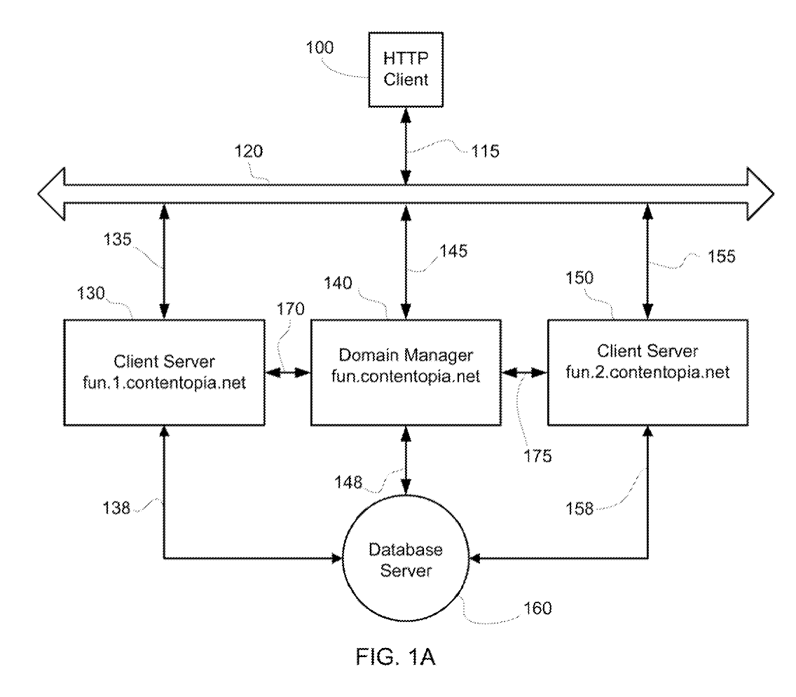

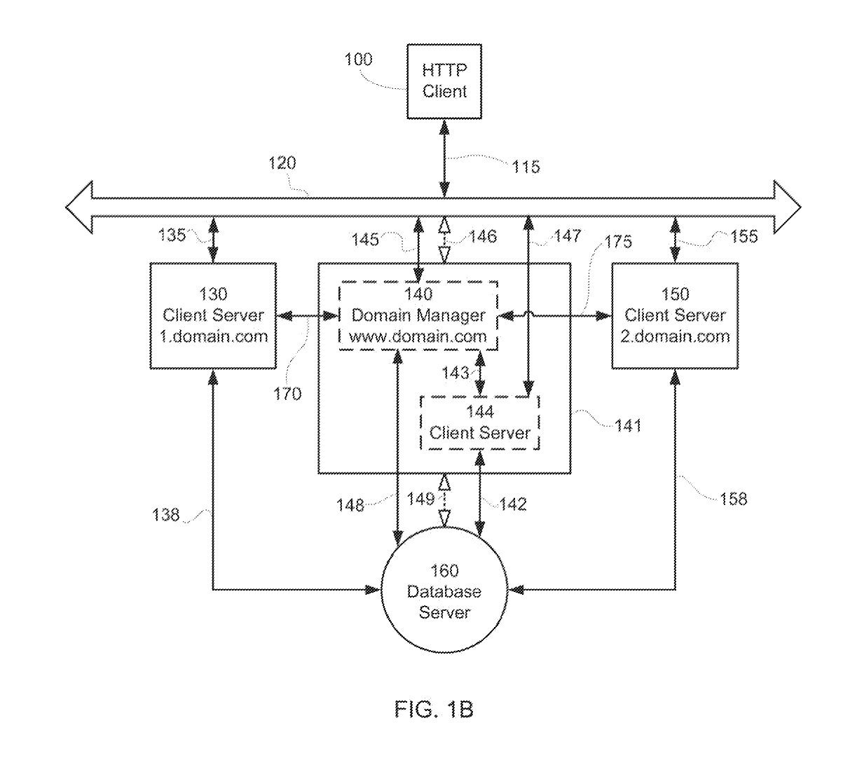

FIG. 1A shows aspects of a cluster server according to various embodiments. The cluster server has a domain manager (DM) 140. The DM is a cluster server manager for selectively redirecting web traffic. The DM redirects HTTP requests received from HTTP clients such as web browsers. The cluster server also includes client servers (CSs) 130 and 150. DM 140 and CSs 130 and 150 are operable to communicate with clients connected with network 120 by way of connections 135, 145 and 155 to network 120. In some embodiments network 120 is the internet.

DM 140 communicates with client servers 130 and 150 by way of secure communication channels 170 and 175. Secure communications channels 170 and 175 are over point to point wiring in some embodiments. However there are other embodiments where one or both of these secure communications channels are virtual communications channels secured by an encrypted protocol and carried over a public network such as the internet (e.g. a virtual private network, public/private key encryption, etc.). Furthermore, in various embodiments secure communications channels 170 and 175 are carried in signal media such as optical, radio, microwave infrared, ultrasound, and others, in single or in combination. The signal media can propagate over Ethernet, various wires and/or cables, optical fiber, through free space, and/or others in single or in combination, depending on the application. However the networks, media, protocols and signal sending modalities are not limiting and various other means are operable to implement the secure communications channels for the cluster server, depending on the application.

A cluster server after FIG. 1A also includes a database server (DS) 160 that communicates with DM 140, CS 130, and CS 150 by way of respective secure communications channels 148, 138, and 158. The DS is inaccessible from client network 120. One aspect of the DS is to store information relating to an HTTP client such as HTTP client 100 in a database. In various embodiments, the stored information includes a session identification descriptor for an HTTP session. The session identification descriptor is for a server or manager in the cluster server to access stored information relating to the client and/or the session. In some applications the session identification descriptor is used to associate multiple transactions together and/or maintain data specifically associated with an application. Data associated with a session identification descriptor is sent to a DS from one CS and/or DM and stored in a database with the session identification descriptor. The data is often received by a different CS and/or DM. The different CS and/or DM obtains the data from a DS, using the associated session descriptor. The session identification descriptor is a number in some embodiments.

A purpose for having the communications channels between the modules of the cluster server be secure is to insure privacy and system integrity. However there are some applications where a cluster server is configured with some insecure communications channels. For example, an insecure communications channel is desirable and less costly in some applications where the communications between modules are intercepted for development, demonstration and/or testing. Cluster servers configured to have insecure communications channels between some modules of the cluster server are within the scope and spirit of an aspect of the invention.

In an embodiment after FIG. 1A, secure communications channels 170, 175, 138, 148, and 158 between the modules of a clustered server are implemented with point to point wired connections. The secure communications channels in this embodiment coincide with the physical point to point connections. However there are other embodiments where some secure communications channels are implemented as virtual secure communications channels over a private local area network. There are also embodiments in which secure communications channels of a cluster server are carried in virtual private networks over the internet. The exemplary secure communication channels shown in FIG. 1A and those in other embodiments do not limit the scope of the claims herein. In various other embodiments, secure communications channels are implemented over point to point physical wiring, a private local area network, a virtual private network carried over a public network such as the internet, and others, in single or combination. Also, there are less preferred embodiments where insecure communications channels are used in place of some or all of the secure communications channels.

In an embodiment after FIG. 1A, DM 140 is operable to receive HTTP requests sent from various HTTP clients connected with the internet, such as requests from an exemplary HTTP client 100. The client HTTP requests are sent to an internet protocol (IP) address associated with the uniform resource locator (URL) of the domain. When an HTTP request from a client is a GET request for content of the client server, the DM selects a CS of the cluster server to provide the information sought. The CS that is selected by the DM can be any CS of the cluster server that can provide the requested content.

Another cluster server embodiment is shown in FIG. 1B. Various embodiments after FIG. 1B include logical modules DM 140 and CS 144 in a physical unit 141. DM 140 redirects HTTP requests received from HTTP clients such as web browsers. The cluster server also includes CSs 130, 144 and 150. DM 140 and the client servers 130, 144, 150 are operable to communicate with clients connected with network 120 by way of communications channel segments 135, 145 and 155. In some embodiments network 120 is the internet.

The embodiments also include a DS 160 that communicates with DM 140 by way of secure communications channel 148, and with CS 130, CS 144 and CS 150 by way of secure communications channels 138, 142, and 158, respectively. DS 160 is inaccessible to any unit outside of the cluster server. Logical modules 140 and 144 comprise control circuits in physical unit 141 that are operable to perform the respective functions of those modules. It will be understood that a logical module is often implemented with media having instructions and data operable to perform the functions of a module, and a processor that is operable perform the instructions and operate on the data.

DS 160 is a physical unit in various embodiments after FIG. 1B. However there are alternate embodiments where a logical DS and a logical CS are in the same physical unit. Furthermore, there are alternate embodiments in which some physical units that have a plurality of logical modules selected from various other combinations of a DM, DS modules, and CS modules. In some embodiments the logical modules in a physical unit communicate with each other by way of internal communications channels in the unit. For example, a cluster server according to FIG. 1B has an internal communications channel 143 for sending information between DM 140 and CS 144.

Some embodiments after FIG. 1B have secure communications channels 138, 170, 175, 148, 142, and 158 between modules implemented over point to point cable connections. Furthermore, there are embodiments in which secure communications channels 138 and 158 are each coextensive with one point to point cable connection for carrying the respective secure communications channel. In these coextensive embodiments, lines 138 and 158 in FIG. 1B can be viewed as additionally representing the associated physical connections.

Open arrow dotted lines 146 and 149 in FIG. 1B represent physical connections that are implemented only in selected embodiments. In an embodiment where connection 149 is unimplemented, secure communications channel 148 is carried over physical media comprising a first network interface connection (NIC) in physical unit 141 that is associated with DM 140, a second NIC in DS 160, and a cable for carrying signals between these two NICs. Also in this embodiment, secure communications channel 142 is implemented with a third NIC in unit 141 for CS 144, a fourth NIC in DS 160, and another able for carrying signals between the third and fourth NICs. In this embodiment secure communications channel 148 is substantially coextensive with the aforementioned physical media connection between DM 140 and DS 160, and secure communications channel 142 is substantially coextensive with the aforementioned physical media connection between CS 144 and DS 160.

In another embodiment, physical connection 149 between unit 141 and DS 160 is implemented. Here physical connection 149 consists essentially of one NIC in physical unit 141, one NIC in DS 160 and a cable connection between two NICs. In this embodiment secure communications channel 148 and secure communications channel 142 are virtual channels carried over physical connection 149 between 141 and 160.

In some alternative embodiments physical connection 146 is unimplemented. In these embodiments communications channel segment 145 is carried over one physical connection between physical unit 141 and network 120, and the communications channel segment 147 is carried over another different physical connection between unit 141 and network 120.

In some yet further embodiments physical connection 146 is implemented. In some of these further embodiments signals between physical unit 141 and network 120 by way of physical connection 146 carry communications channel portions 145 and 147.

It will be apparent that various secure and insecure communications channels can be sent over different physical media and path segments, depending on the embodiment. Furthermore, various secure and insecure communications channels can be sent over local area networks, public networks, diverse point to point wire connections, and/or other signal carrying means, in single or in combination. Those of ordinary skill in the art will recognize that secure and insecure communications channels can be implemented in various other useful ways. The implementation of secure and/or insecure communications channels in various embodiments does not limit the scope of the claims herein.

Cluster servers after FIG. 1A and/or FIG. 1B have a DM that is operable to receive HTTP requests sent from various HTTP clients on a network such as the internet. In embodiments such FIG. 1A, the DM is a physical module and all of the CSs are physical modules. However, in an embodiment after FIG. 1B, DM 140 is in a physical unit 141 that includes a logical CS 144. Furthermore, there are a number of other cluster servers having at least one physical unit comprising a plurality of modules selected from DM modules, DS modules, CS modules, and subordinate cluster server modules. Subordinate cluster server modules are further described below.

With reference to FIG. 1B, when the DM 140 receives a GET request from client 100, it selects a CS that has access to the information sought. Where the DM and the selected CS are in different physical units, for example when CS 130 is selected for the GET request, DM 140 sends a redirection message to client 100 to send a redirected the GET request to the selected CS 130. However, in some preferred embodiments where a DM and the selected CS are both modules within the same physical unit, the GET received by the DM is directly sent to the selected internal CS rather than being redirected. By way of example, a GET request from client 100 is received by DM 140, and DM 140 selects internal CS 144 for sending the requested information. Accordingly, the DM module 140 forwards the GET request to CS 144 by way of internal secure communication channel 143 in the same physical unit. Hence there is no redirection. Responsive to receiving the forwarded GET request from DM 140, CS 144 transmits the requested information to HTTP client 100. In this aspect, sending the GET directly from DM 140 to CS 144 by way of secure communications channel 143 avoids unnecessary physical network traffic and latency.

In a less preferred alternative embodiment, one GET request from a client is received by a logical DM in a first physical unit. The DM selects a logical CS in its same physical unit to service the GET. Although the CS is internal in the same physical unit, the DM nevertheless sends a redirection message over network 120 to the client for redirecting the GET request back to the internal logical CS in the physical unit of the DM. The client receives the redirection message and responsively sends a once redirected GET request to the selected logical CS module. The CS module receives the GET request and responsively sends the requested content over network 120 to the client. In this less preferred embodiment, the GET request for content is sent by redirection to the selected internal CS in the DM same manner as redirection to an external CS in a different physical unit. This logical symmetry is useful in some embodiments.

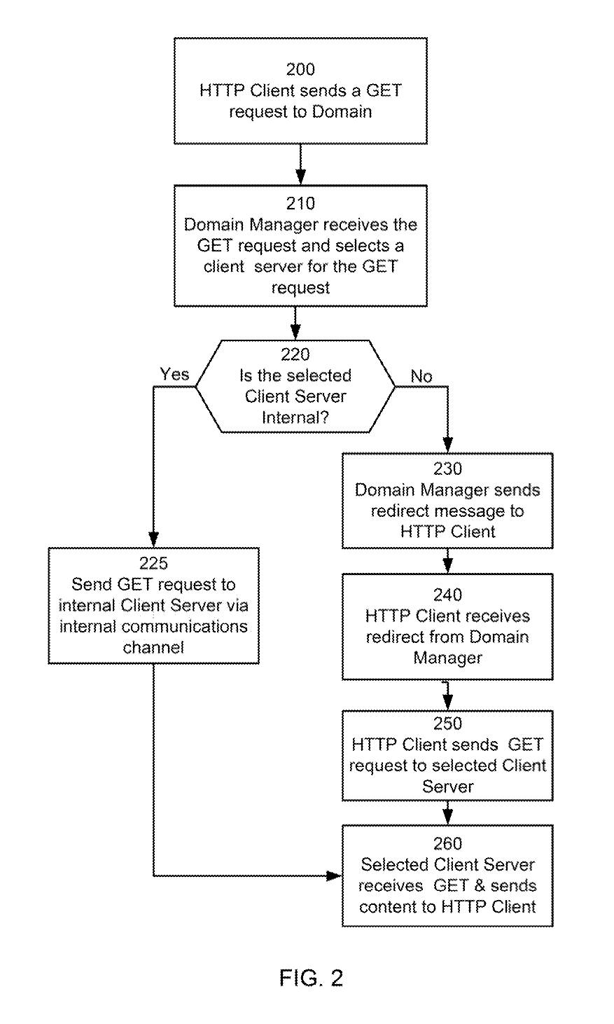

A block diagram showing aspects of a cluster server method is in FIG. 2. At block 200, an HTTP client such as a web browser sends a GET request for content to a domain. The GET request is received by the domain manager for the domain. The DM is a host for receiving HTTP requests that are sent to an internet address associated with the notorious uniform resource locator (URL) of the domain. The notorious URL is, by convention, often the domain name and/or a prefix to the domain name (e.g. domain.com and/or www.domain.com, where “domain.com” is the name of the domain). The DM is a traffic redirector for the domain. After receiving the GET request for content from the client at block 210, the DM selects a CS of the cluster server for servicing the GET, without any user interaction.

In some aspects the DM and selected CS are in different physical units. In these aspects, at block 220 the DM decides to redirect the GET request to the selected CS for responding according to blocks 230, 240 and 250. At block 230, the DM sends a redirection message to the HTTP client for redirecting the GET to the select CS. The redirection message comprises a URL of the selected CS for redirecting the GET. At block 240, the redirection message is received by the HTTP client. At block 250, the HTTP client sends the GET request to the selected CS by way of the redirection URL. The selected CS receives the GET request at 260 and responsively sends the requested content to the HTTP client.

In some further aspects, the selected CS is a logical module internal in the physical unit of the DM. In these aspects steps 230, 240 and 250 are not performed. Here, the GET request from Block 200 is received, and content is sent to the HTTP client from the CS in that physical unit, without redirection. Responsive to receiving the GET request and selecting the internal CS, the DM sends that GET request to the internal CS by way of an internal communications channel according to Block 225. At Block 260 the selected internal CS receives the GET from the DM, and responsively sends the requested content to the HTTP client.

As to selecting a CS, in some embodiments a CS is selected using a predetermined method such as a round robin method. In a round robin method each of the CSs is selected in turn by way of rotation. For examples in one round robin method used in an embodiment of the cluster after FIG. 1B, a first GET request received by the DM 140 is redirected to CS 130. A second GET request received by DM 140 is sent to internal CS 144 within the physical unit of DM 140 (this GET is not redirected). A third GET request received by DM 140 is redirected to CS 150. The sequence is repeated starting when a fourth GET request is received by DM 140 (e.g. the fourth GET request is redirected to CS 130).

In further embodiments, selecting a CS is based on the CS having resources available. For example, in one embodiment certain CSs have exclusive access to first content. When the DM receives a GET request for the first content, it selects one of the CSs that is operable to access and send that first content to the client. Another cluster server embodiment has five CSs. Two of these five CSs have access to a mirror of a multimedia library. The remaining three CSs have no access to that library. In this embodiment, requests to the DM for content of the multimedia library are exclusively redirected to the two CSs with access to the multimedia library, in round robin. In yet another aspect, a CS is selected to send requested content based on its having sufficient unutilized processing capacity to send the content with minimal latency. Numerous further methods are also useful for selecting a CS. In an alternative cluster server embodiment, a DM selects the CS for a GET request based on that CS having the lowest load relative to its processor power and relatively greatest unutilized bandwidth in its communications channels. Selecting a CS in yet another embodiment depends on parameters selected from: available computational capacity, predicted latency, relative CS utilization, time elapsed since the last GET received, and others. These simplified embodiments should not limit the scope of the claims herein. Those of ordinary skill in the art will recognize that other CS selection methods will be useful to practice aspects of the invention, depending on the application.

Depending on the embodiment, a DM obtains information about resources of the CSs in various ways. In some embodiments after FIG. 1B, DM 140 interrogates CS 130 for status information by sending an interrogation message to CS 130 in secure communication channel 170. Responsive to the interrogation, CS 130 returns information characterizing its resources, load average and other static and dynamic characteristics to DM 140 by way of secure communication channel 170. In the same manner, DM 140 obtains status information about the resources, load and other static and dynamic characteristics of CS 150 by way of secure communications channel 175. There are also embodiments in which CS 130 and CS 150 “push” status information to DM 140 without receiving a request from DM 140. Furthermore, according to various embodiments, status information concerning the resources, load and other static and dynamic characteristics of CS 144 is requested by the DM, and/or is “pushed” over the internal communication channel 143 in the physical unit of the DM. In these embodiments a DM often obtains information for selecting a CS by receiving information responsive to interrogation messages, and/or receiving information “pushed” from CSs by way of various communications channels. However these methods are not limiting. For example, different aspects that are described below include subordinate clusters that have subordinate cluster managers (SCMs). Subordinate cluster managers are traffic redirectors for the subordinate clusters. In some of these aspects, a DM obtains various status information concerning a CS from an SCM.

In some CS embodiments, a database is mirrored in a plurality of physical DSs. One embodiment has a database mirrored in a pair of physical DSs. In the event that one DS of the pair is unavailable as, for example, when some physical hardware of the first DS fails, the second database server remains operable to provide information from its database mirror.

Another exemplary cluster server includes a first, a second and a third DS. Each of these DSs has a mirror of a transaction database. Selected CSs of the cluster server are configured for accessing the transaction database by way of a DS. In one embodiment, the DM detects hardware failure of the first DS. Responsive to detecting the failure, the DM reconfigures the selected CSs of the cluster server to effectuate access to the database exclusively through the second and/or the third DS. In an alternative embodiment, at least one of the selected CSs is operable to detect that the first DS has failed. In this embodiment, the one CS reconfigures itself to access the transaction database exclusively by way of the second and/or third DS(s). It can be seen that CSs in the various respective embodiments are often operable to access the database despite a DS failure. Hence it can be seen that mirroring a database in a plurality of DSs improves reliability. These simplified embodiments do not limit the scope of embodiments. Those of ordinary skill in the art will appreciate that various other methods are operable to obtain access to a database in the event that one or more DSs become unavailable, depending on the application.

Database mirrors are also useful to reduce latency in various embodiments. There are embodiments where different CSs obtain simultaneous parallel access to a database by way of a plurality of DSs accessing mirrors of the database. In some of these embodiments, parallel sending and receiving information to and from the database is performed by way of different communications channels that are carried over distinct physical carrier media to and/or from various DSs. The overall available bandwidth for data transfer is thereby increased. In still further embodiments a plurality of CSs and/or managers of the cluster are operable to simultaneously send and/or receive data from the same database mirror by way of at least two DSs. Hence it is seen that a cluster server having a multiplicity of database servers often has relatively greater throughput, reduced latency and improved reliability.

In a number of embodiments, there are online database mirrors that are substantially synchronized with each other in real time using standard methods. For example, one method is based on comparing time codes associated with individual records in one mirror to the last update times of other mirrors. In some embodiments, installing a new DS into a cluster server for mirroring a database includes storing a substantially up to date copy of the database in the new DS as part of the installation process. There are other embodiments where a stale copy of the database is in machine readable media of a DS before that DS is placed in service. In some of these embodiments, installation comprises synchronizing the stale copy with online mirror(s) of the database. In various embodiments a DS is operable to be installed into a cluster server and placed online without human interaction.

Another cluster server embodiment includes a spare DS unit. The cluster server is configured to have the spare DS be inaccessible to any CS of cluster. Selected CSs of the cluster server have access to a mirrored database by way of at least one other accessible DS. An up to date mirror of the database is maintained in the spare DS during normal operation of the cluster server. Upon the occurrence of an event causing an accessible DS to become inaccessible, the spare DS is reconfigured to provide access to the database for some CSs. For example, in one aspect an accessible DS has hardware failure or software corruption, and the cluster server is reconfigured for the spare DS to provide substitute access in place of the failed DS. Hence the first DS can be removed for repair with little or no impact on cluster server function. In various embodiments, the cluster server is operable to effect such reconfiguration without human interaction.

Yet another embodiment has at least two mirrors of a database in machine readable media. The two mirrors are accessible to a first DS. For example, there embodiments having two mirrors of a database maintained in a duplexed RAID level 1 hard disk array. In some of these embodiments, the array has a RAID controller with at least two ports. The disk media is coupled to the first DS by way of one port, and the disk media is coupled to a second DS by way of another port. There are two mirrors of the database accessible by way of the first and/or the second DS. It will be apparent to those of ordinary skill in the art that this embodiment is tolerant of media error as well as a failure of either DS. Hence it can be seen that a cluster server is fault tolerant according to aspects of the invention. These simplified embodiments are merely exemplary, and do not limit the scope of the claims. It will be apparent to those of ordinary skill in the art that various other methods and apparatus are useful to provide fault tolerance in different embodiments, depending on the application.

In a preferred embodiment after FIG. 1A, DM 140 includes a 2 GHZ AMD® 280D+ processor with 1.5 GB random access dynamic memory (D RAM), a 500 GB hard disk drive, and a Microsoft Windows® 2003 standard operating system. DM 140 further includes three 10/100/1000 Mb/s network interface cards (NICs). Connection 145 between DM 140 and the internet 120 comprises one 10/100/1000 Mb/s NIC in the DM, a digital subscriber line (DSL) modem that interfaces to the internet 120, and category 5 (CAT 5) cable to couple the NIC to the DSL modem. The embodiment also includes secure communications channel 170 between DM 140 and CS 130, and secure communications channel 175 between DM 140 and CS 150. Each of these communications channels is carried over and is coextensive with a physical carrier path comprising a NIC in DM 140, a NIC in the respective CS (130 or 175), and CAT 5A twisted pair cable coupling the NICs. Also, secure communications channel 148 between DS 160 and DM 140 is carried over and coextensive with a physical carrier path comprising one NIC in DM 140, one NIC in DS 160, and CAT 5 cable coupling the NICs to one another.

DM 140 also has Apache 2.0 web server software and ColdFusion MX7 Enterprise® software for performing instructions and operating on data. In this regard, DM 140 includes instructions and data operable to receive a GET request for content from an HTTP client 100, to implement a round robin method for selecting a CS to deliver the contents and to redirect the GET request to the selected CS. The embodiment has program code operable to select CS 130 or CS 150 for servicing the GET request. Furthermore, DM 140 includes instructions operable to send information to DS 160 for storing in a database. DM 140 also has instructions operable for sending a request to DS 160 for data, and for receiving data from DS 160. DM 140 also has instructions operable to receive status and various other data from DS 160, CS 130 and CS 150.

In some embodiments after FIG. 1A, an internet web browser in a personal computer includes HTTP client 100. A method of obtaining content from a cluster server according to the present disclosure can be further understood with reference to these embodiments. A user of the personal computer requests content from the internet domain at URL fun.contentopia.net by way of a user interface of the web browser. Responsive to the user request, the HTTP client 100 of the browser sends a GET request for the content over the internet to URL fun.contentopia.net. Without user interaction, the URL is resolved by a domain name server (DNS) to an IP address associated with DM 140. The GET request from the browser client is routed to DM 140 by way of connection 115, the internet 120, and connection 145. DM 140 receives the GET request from client 100.

In some aspects of the embodiments, DM 140 sends data to DS 160 for storing in a database. The data includes information relating to client 100 that is received in the GET request. There are aspects where the data also includes an associated session identification.

Responsive to receiving the GET request from browser client 100, DM 140 selects a CS from CS 130 or CS 150 for servicing the GET request, without user interaction. In the embodiment, a URL of each CS is a unique prefix to a URL of the domain. URL fun.1.contentopia.net is associated with CS 130 and URL fun.2.contentopia.net is associated with CS 150. Here the URL fun.1.contentopia.net of CS130 has the unique prefix “fun.1” and the URL fun.2.contentopia.net of CS 150 has the unique prefix “fun.2”. In one aspect, DM 140 selects CS 130 for servicing the get based on a round robin method. DM gives effect to selecting CS 130 by sending an HTTP message to browser HTTP client 100. The HTTP message from DM 140 is to redirect the GET request to the URL fun.1.contentopia.net associated with CS 130. The HTTP client 100 of the browser receives this HTTP message from DM 140 for redirecting the GET request. Responsive to receiving the HTTP message for redirecting, and without any user interaction, the HTTP client 100 sends a GET request for the content to the URL fun.1.contentopia.net associated with CS 130. Hence the redirected GET request from HTTP client 100 is received by CS 130.

In various aspects, CS 130 obtains a session identification descriptor from the redirected GET request. In a number of these aspects CS 130 sends a query to DS 160 for data in the database. The query includes the session identification descriptor for access in some aspects. DS 160 returns the requested data from the database to CS 130. The data comprises information relating to the client that was sent to from DM 140 to DS 160 for saving in the database. Responsive to receiving the redirected GET request, CS 130 sends an HTTP message with the requested content to HTTP client 100 of the web browser. In some aspects the requested content includes the information CS 130 received from the database.

Also, there are further aspects where CS 130 sends some further information relating to client 100 to DS 160 for saving in the database. The further information is later accessed by DM, CS 130 and/or CS 150 by way of DS 160, to provide content for a different GET request.

After the user of the PC enters a request for content from fun.contentopia.net, the content is received in the browser without any further user interaction. The initial GET request for content that was sent to DM 140 thereby results in the content being delivered to the browser in an HTTP message from CS 130. Hence load balancing is performed by the cluster server without any user interaction related to the load balancing method. It can be seen that redirecting the GET request from the DM to a selected CS is transparent to an ordinary user of the PC.

To facilitate explanation, only one illustrative HTTP client 100 is shown in the FIG. 1A. However, in various embodiments there are many HTTP clients that often send numerous GET requests over a networks such as network 120, to a DM, such as DM 140. It will be apparent that there is a need for relatively increased data processing capability and network bandwidth as increasing numbers client requests are received in predetermined time interval (e.g. as traffic to the domain increases). The cluster server architecture and methods disclosed herein are to distribute client content requests among the CSs of a cluster server for processing, thereby providing increased processing capability. Furthermore, in many embodiments, various CSs have independent parallel connections to a client network 120. In some embodiments network 120 is the internet. Multiple parallel connections between the cluster server and the client network, as exemplified by connections 135 145 and 155 to network 120 in the embodiments of FIG. 1A and FIG. 1B, provide scalable bandwidth for data transmission. It can be seen that the cluster server architecture provides a method and system for incrementally increasing data processing capability and for incrementally increasing bandwidth to network 120, thereby reducing latency.

In one embodiment, a cluster server configuration having two CSs according to FIG. 1A is expanded to include seven CSs. Hence five CSs are added. Installing the five additional CSs includes making three connections to each one. The three connections are between each additional CS and DM 140, DS 160 and the client network 120. That is, each additional CS is connected in the same manner as the preexisting connections to CSs 130 and/or 150 as shown in FIG. 1A (e.g. CS 130 has the three connections 135, 138 and 170 to the DM, the DS and the client network). It can be seen that adding the CSs increases the capacity of the cluster server for servicing GET requests in relation to the number of CSs that are added. In various embodiments, the user experience often improves as a cluster server is configured to have more client servers.

In another embodiment after FIG. 1A, CS 130 is a physical unit and CS 150 is another physical unit. CS 130 and CS 150 have like configurations, operating systems, application software and content. In the embodiment, CS 130 and CS 150 each have a 2.8 GHZ Pentium® D processor, 4 GB DRAM, a 1000 GB hard disk drive, 3 NICs, and a Microsoft Windows® 2003 standard operating system. Furthermore, CS 130 and CS 150 each have Coldfusion MX7 Enterprise® server software. Both of CS 130 and CS 150 have instructions operable to receive a GET command from an HTTP client, and responsively send the content that is requested to the client. CS 130 and CS 150 also include instructions and data operable to communicate with DM 140. In the embodiment, DM 140 obtains information from each CS concerning its processing capability, load average, transaction latency, accessible content and other parameters.

The embodiment also includes a DS 160 and a database. In the embodiment, the database is in machine readable media of physical DS 160. DS 160 has a 2.7 GHZ AMD® 4700+ processor, 4 GB DRAM, two 1000 GB hard disk drives, 3 NICs, and a Microsoft Windows® 2003 standard operating system. Furthermore DS 160 includes a 64 bit wide bus for fast access to DRAM and 64 bit SQL Server 2005 server software The SQL server software is operable to save information to the database and retrieve information from the database, responsive to requests from CS 130, CS 150, and/or DM 140. DM 140, CS 130 and CS 150 include instructions operable to send information to DS 160 for storing in the database, and to request and receive information from the database. The various requests and responsive information are sent to and received from DS 160 by way of secure communication channels 138, 148 and 158.

In various alternative embodiments, a plurality of CSs have different characteristics from each other. In some embodiments, they have different physical configurations, different operating systems, different application software, and/or different content, in single or in combination. Depending on the embodiment, the DM selects a CS for servicing a GET request based on a variety of factors. The factors include, but are not limited to, availability of requested content at a CS, the relative load on each CS, and/or estimated latency for delivering content to an HTTP client from each respective CS.

In an embodiment after FIG. 1A, DM 140 receives a GET request from an HTTP client. DM 140 selects one of CS 130 and CS 150 for sending the content requested by the GET. The selecting is based on a load-balanced request routing algorithm. The selecting also depends on the content accessible to each CS. DM 140 obtains updated information from CS 130 and CS 150 concerning resources of each respective server that are already committed for servicing active requests. After selecting a CS, DM 140 sends a redirection message to HTTP client 100 for redirecting the GET request to the selected CS. The redirection is to the URL fun.1.contentopia.net of CS 130 or the URL fun.2.contentopia.net of CS 150, or to an IP address associated with the URL of the selected CS, depending on the embodiment.

In numerous embodiments, a cluster server is compatible with any CGI language or content delivery software system such as ColdFusion®, PHP, Perl, JSP, ASP, ASP.NET and others. Moreover, any CGI based language that is operable to access an ODBC or native SQL server data source is useful to practice the embodiments. Furthermore, alternative embodiments include an AJAX application framework and ColdFusion® for providing content responsive to a GET request.

Also, in various embodiments a DM provides an administrative interface to the cluster server over a secure communications channel. The administrative interface to the DM is operable to access various parameters of the cluster server with a web browser. Depending on the embodiment, administrative access to the DM allows an authorized administrator to modify the configuration, operating parameters, and/or content of the various units in the cluster server (e.g. a CS, a DS, and/or a manager). In various embodiments administrative access to the DM is also for adding or decommissioning a CS and/or a DS, into or from the cluster server. From time to time, a CS or DS is decommissioned for maintenance in some embodiments. There are also embodiments in which a CS or DS is decommissioned when an actual and/or imminent hardware and/or software failure is detected. For example, in one alternative embodiment after FIG. 1B, a failure in CS 130 is detected by DM 140 and CS 130 is responsively decommissioned using a control circuit in the DM, with no user interaction. In further embodiments, a CS has instructions and data in machine readable media operable for a processor of the CS to detect a failure, push a message for decommissioning that CS to the DM, and power itself down, in single or in combination.

Depending on the embodiment, administrative access for configuration and/or administration of a module in a cluster server can be performed using HTTP, a telnet session, and/or other protocols in a secure communications channel such as a secure sockets layer. It will be understood that the protocol and physical connections for secure administration are not limiting and various alternative secure means are often useful, depending on the embodiment. In some alternative embodiments, a web interface for secure administration of a DM is provided. Also, a CS and/or DS can be alternatively administered and/or configured by an administrator using a secure user interface to the DM and/or a secure user interface directly to the CS and/or DS respectively, depending on the embodiment.

In various embodiments, a server and/or manager of a cluster server is often an ordinary personal computer. However hardware and/or software that is designated as being for workstations, servers and/or various other configurations is also useful. One suitable CS embodiment has physical interface connections for communicating with a client network (for example the network 120 of FIG. 1A or FIG. 1B), a DM, and a DS. In an embodiment of FIG. 1A, there are three physical interface connections with CS 130 including one connection 135 to a network 120, one connection 170 to a DM 140, and one connection 138 to a DS 160. Here each of the various connections is for one physical transmission medium carrying a single communications channel. However there are other embodiments where a plurality of communications channels are carried in signals sent by way of one single physical connection.

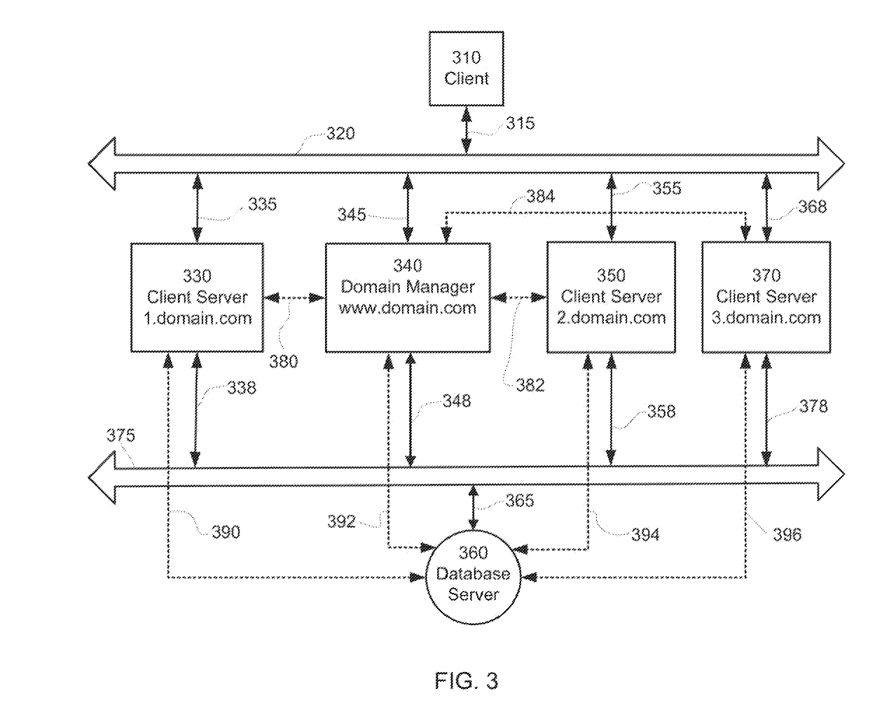

In an embodiment according to FIG. 3, various double arrow solid connection lines such as lines 335, 345, 355, 368, 338, 348, 358, 365, and 378 represent physical connections for sending signals carrying communications channels. The various dotted double arrow connection lines, on the other hand, such as 380, 382, 384, 390, 392, 394, and 396, represent secure communications channels. A secure communication channel between selected units often traverses different physical connections at different times. For example, a segment of one secure communications channel between a CS and a DS in a cluster server s carried by packets in the transport layer of a local area network. In various aspects these packets are routed over a first set of physical layer connections at one time, and a different set of physical layer connections at another time, depending on network traffic and/or other network characteristics.

By way of example, it can be seen that CS 330 in FIG. 3 has two physical connections 335 and 338. Also, DS 360 has only one physical connection 365. In one alternative embodiment according to FIG. 3, secure communications channel 380 between CS 330 and DM 340 is carried by signals traversing 338, 375 and 348. Secure communications channel 390, between CS 330 and DS 360, is carried by signals traversing 338, 375 and 365 in the embodiment. Hence secure communications channels 380 and 390 are both carried by various signals traversing physical connection 338 and the physical network 375 in the embodiment. Further details of some secure communications channels according to FIG. 3 are presented below. It will be apparent that servers and/or managers of a cluster server have various numbers of physical layer connections, depending on the embodiment. The number of physical connections that each of the various servers and/or managers of a cluster have does not limit the scope of the claims.

Various embodiments according to FIG. 3 have three CSs 330, 350 and 370, one database server 360, and one DM 340. DM 340 and CSs 330, 350 and 370 have physical connections 335, 345, 355 and 368, respectively, with network 320. The various embodiments also have physical connections 338, 358, and 378, respectively, between CSs 330, 350, and 370 and network segment 375. The embodiments further include physical connection 348 to couple network segment 375 with physical domain manager 340. Also physical connection 365 is for coupling network segment 375 with database server 360.

Various physical connections provide portions of a physical layer for TCP/IP sessions of HTTP client 310 with the DM and/or the various CSs in embodiments. Other connections provide physical layer signal carrier paths for secure communications channels between various units of the cluster server. Depending on the embodiment, operable physical carrier paths can be coaxial cable, wired pairs, point to point wiring, optical fiber, wireless radio waves, infrared, light waves, microwaves, and various other signal carrying means and/or combinations thereof. In some embodiments there are direct point to point physical signal path connections between the various clients and servers. In further embodiments, some physical signal path connections are by way of routers, switches, access points, bridges, and the like, in single or in combination. Furthermore, in a number of embodiments network 320 is the internet.

In an aspect, DM 340 receives a GET request for content from client 310 and selects CS 330 for sending the requested content. Accordingly DM 340 sends a message to HTTP client 310 to redirect the GET request to CS 330. Client 310 receives the redirection message from DM 340 and responsively sends the redirected GET request to CS 330. CS 330 then receives the redirected GET request from client 310 and corresponding sends the content requested to client 310. In FIG. 3, various physical layer signal paths comprising the hollow double arrowed segments 320 of network and/or network 375 will be apparent. Some of these signal paths support communications between some modules of the cluster server, and other paths carry communications of a client, such as client 310, with a DM and/or CS.

In some embodiments network 320 and network 375 are separate disjoint physical network media. However there are alternative embodiments where networks 320 and 375 are communicably coupled to one another. In various embodiments, networks 320 and 375 are variously coupled to each other by cabling, fiber optics, wireless signal paths, routers, bridges and/or other physical connection means (not shown FIG. 3). In some embodiments network 375 is effectively a portion of network 320. Furthermore, in some alternative embodiments, network 320 and/or network segment 375 are effectively portions of a public network such as the internet.

Internal communications within a cluster server, according to various embodiments, are preferably over secure communications channels. A secure communications channel is carried over insecure physical media in some embodiments. With reference to FIG. 3, secure communications channels between various pairs of modules are designated by dashed lines 380, 382, 384 390, 392, 394 and 396. These secure communications channels are for sending information between the logical and/or physical units of the cluster server in a secure and reliable manner. In the embodiments, secure communications of CSs 330, 350 and 370 with DM 340 are sent over secure communications channels 380, 382, and 384.

Physical carriers signals of at least some secure communications channels often traverse network segment 375. By way of example, a signal carrying information for secure communications channel 380, from CS 330 to DS 340, traverses physical connection 338, network 375, and physical connection 348. Also, there is an embodiment in which signals for secure communications channel 382 between DS 340 and CS 350 traverse connection 348, network segment 375 and connection 358. Furthermore, signals carrying secure communications channel 392 traverse connection 348, network 375 and connection 365 in some embodiments. Further physical paths between modules of the cluster server in FIG. 3 will be apparent. These further physical paths are used to carry secure communications channels in various embodiments.

Network 375 is a private local area network in some embodiments. In various aspects, network 375 comprises a plurality of network segments. Segments of network 375 often include wireless, wired, optical fiber and/or other network media, depending on the application. Furthermore, there are embodiments where network 320 and network 375 are coupled to each other. In some embodiments, numerals 320 and 375 in FIG. 3 effectively reference the same network. In embodiments where these networks are coupled, the physical connection pairs 335 and 338, 345 and 348, 355 and 358, and 368 and 378 provide redundant signal paths to network 320/375. Redundant signal paths are useful to improve reliability and provide increased bandwidth for data throughput.

In some embodiments there are secure communication channels having no encryption. For example, in one embodiment, the physical layer signal paths among the DM, CSs and DSs are wholly confined within a secured area. Accordingly, these physical signal paths are operable for secure communication in the secured area without encryption. For example, there is an embodiment where physical connection 338, connection 365 and network 375 are contained within a secure shielded room. In this embodiment, secure communications 390 channel comprises unencrypted information in signals sent over 338, 365 and network 375. Since the physical signals of the channel 390 are confined within the secure shielded room, channel 390 is a secure communications channel.

In yet another embodiment a secure communications channel is carried over one physical segment that is wholly within a secured areas while another physical segment traverses an area that is insecure. In this embodiment the secure communications channel is unencrypted within the secured area, and encrypted in the unsecured area. Hence it can be seen that information in a secure communications channel is encrypted where its physical segments are insecure (e.g. an insecure segment is subject to eavesdropping). Encrypted and unencrypted portions of a network are often coupled with each other by conventional means such as encrypting Ethernet bridges, encryption/decryption embedded in a router or access point, or similar means. Encryption, physical confinement and/or other means for implementing a secure communications channel do not limit the scope or utility of various embodiments.

In the various embodiments after FIG. 3, secure communications channels 390, 392, 394 and 396 carry information between database server 360 and servers 330, 350 and 370, respectively. Also, in some embodiments, secure communications channel 392 is for sending information between DM 340 and DS 360. Network 375 is a local area private network in some embodiments. Network 320 is coupled with a public network in various embodiments. Also, there are embodiments where network 375 is communicably coupled with a public network. In some of these embodiments, the public network is the internet. Also, there are embodiments according to FIG. 3 in which numerals 320 and 375 reference segments of the same network. Hence there are secure communications channels selected from 380, 382, 384, 390, 392, 394, and/or 396 that traverse a public network and/or the internet in some embodiments. Where portions of a secure communications channel are carried over a public network, at least those portions of the secure communications channel are encrypted. A secure communications channel over the internet is encrypted with RSA public key encryption in an embodiment. However, the scope of the claims is not limited by any method of encryption, physical confinement and/or by alternative methods of implementing a communications channel. Furthermore, in some aspects various modules of a cluster server communicate with each other over insecure communications channels.

It can seen that the various embodiments are economically scalable. In many embodiments, the traffic handling capability of a cluster server can be increased at any time by adding one or more additional CSs to the cluster. Various embodiments are operable to be reconfigured without downtime. In some embodiments, a cluster server continuously services GET requests in real time when a CS is being added. Also, as described below, there are embodiments of a cluster server operable to include CSs that are at widely separated geographic locations.

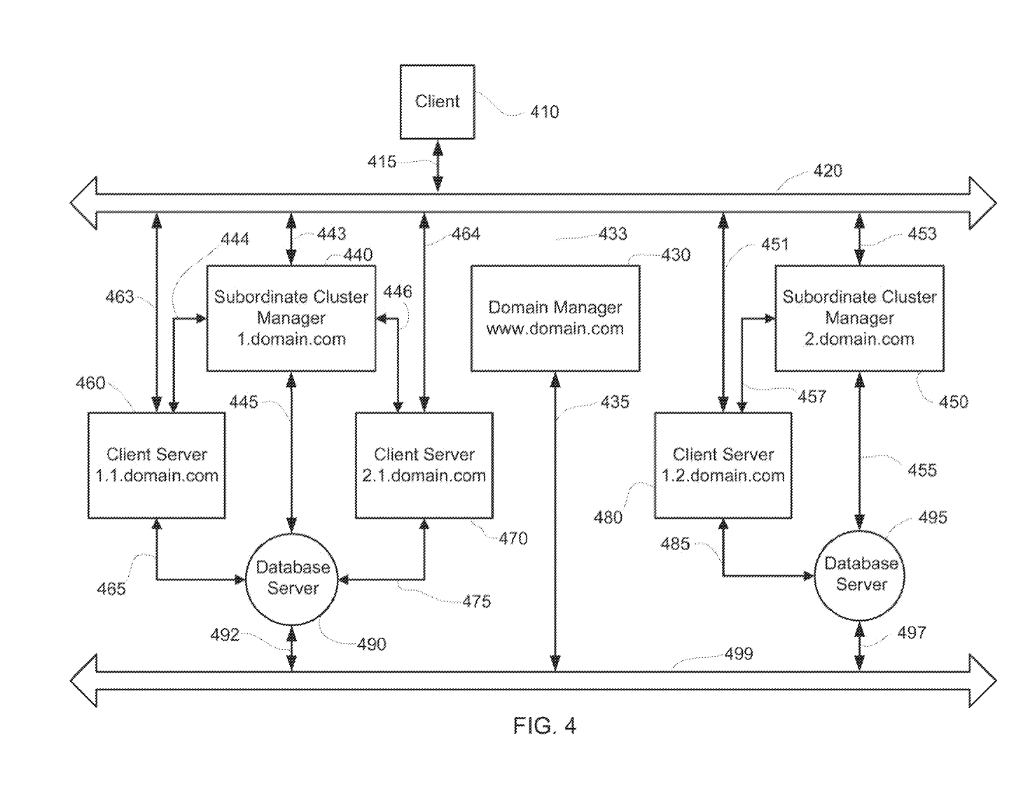

In further embodiments, a cluster server has at least one subordinate cluster. A method and system for a cluster server with a plurality of subordinate clusters can be understood in terms of the exemplary cluster server embodiment shown in FIG. 4. The embodiment has a DM 430 and two subordinate clusters. Each of the subordinate clusters has a subordinate cluster manager. One subordinate cluster (herein referenced as the left cluster) comprises subordinate cluster manager (SCM) 440, CS 460, CS 470 and DS 490. The second subordinate cluster server (herein referenced as the right cluster) comprises SCM 450, CS 480, and DS 495. Physical units 460, 440, 470, 430, 480, and 450 have respective physical connections 463, 443, 433, 451 and 453 to network 420. In some embodiments network 420 is a public network such as the internet. Furthermore DS 490, DM 430 and DS 495 have physical connections 492, 435, and 497 respectively to network 499. In some embodiments network 499 is a private network. In different embodiments network 499 is a public network. In additional embodiments networks 420 and 499 are coupled with each other, and in still further embodiments numerals 420 and 499 reference portions of the same physical network. In some embodiments, different subordinate clusters are deployed relatively close to each other. However, in other embodiments there are subordinate clusters deployed at widely separated geographic locations. A cluster server having subordinate clusters is also referred to as a distributed cluster server.

In an exemplary transaction occurring in some embodiments of FIG. 4, HTTP client 40 sends a GET request for content to a notorious URL of the domain. In the embodiments the domain is domain.com and a notorious URL for requesting content is www.domain.com. The URL www.domain.com is associated with DM 430. The GET request is sent from HTTP client 410 by way of physical connection 415 to network 420, and from network 420 to DM 430 by way of physical connection 433. In the embodiments, network, 420 is often a portion of a public network such as the internet. DM 430 selects a subordinate cluster for servicing the GET. The selecting is from the left subordinate cluster and the right subordinate cluster. In the embodiments, the SCM 440 of the left subordinate cluster and the SCM 450 of the right subordinate cluster are each associated with a URL having a unique prefix to the domain name. Also, the URL of the left SCM 440 is 1.domain.com and the URL of the right SCM 450 is 2.domain.com. The unique prefix of the left SCM is “1” and the unique prefix of the right SCM is “2”. Furthermore, each URL for a CS of a subordinate cluster is comprised of a unique prefix to a URL of the SCM of the subordinate cluster. For example, the URL of CS 460 in the embodiments is 1.1.domain.com which is has the unique prefix “1” prepended to the URL 1.domain.com of SCM 440. Similarly, the URL of CS 480 in the embodiments is 1.2.domain.com which is has the unique prefix “1” prepended to the URL 2.domain.com of SCM 450.

Various distributed cluster embodiments include methods for reducing latency when delivering content to an HTTP client. One method for reducing latency includes receiving a GET request in the DM, selecting a subordinate cluster that manifests relatively low propagation time for sending content to the HTTP client, and redirecting the GET request to an SCM of the selected subordinate cluster. The GET request is redirected to the SCM by sending a message for the redirection to the HTTP client. In various embodiments, the SCM of the selected subordinate cluster receives the redirected GET request from the HTTP client, and responsively selects a CS of that subordinate cluster for sending the content requested by the GET. In various embodiments, the SCM sends a message to the HTTP client to redirect the GET to the selected CS. Hence the SCM is a traffic redirector.

Merely by way of example, in one embodiment the SCM of a subordinate cluster selects a CS using based on a round robin method. In different embodiment, a CS is selected based on an estimated latency for delivering the requested content to the HTTP client. In further embodiments selecting a CS is based on currently available resource capability (e.g. load) in the various CSs of the subordinate cluster. It will be apparent to those having ordinary skill in the art that various other methods are useful to select a CS of the subordinate cluster, depending on the application. The method for selecting a CS does not limit the scope of various aspects.

In an embodiment after FIG. 4, DM 430 is operable to interrogate each SCM (440, 450) and receive information responsive to the interrogation. The information is received from an SCM by way of a secure communication channel between the DM and the interrogated SCM. Depending on the embodiment, a request to an SCM is operable to obtain information relating to the subordinate cluster. For example, one request to an SCM is operable to obtain information comprising available processing resources, latency for sending content, hardware and software configuration of the SCM and/or CSs, accessible content, and others. In further embodiments, status information is sent from an SCM to the DM upon the occurrence of predetermined events, without interrogation from the DM (“push” updating). In various embodiments, some exemplary predetermined events depend on parameters selected from error detection, passage of a predetermined time interval, exceeding a predetermined processor load, excessive latency, and/or others. In some embodiments, selecting a subordinate cluster for a GET request depends on status information. Also, there are embodiments where the performance of some service and administrative tasks is based on status information.

Various methods for selecting an SCM for a GET request are based on the geographical locations of the various SCMs and the HTTP client. In some embodiments after FIG. 4, latency for delivering content from a subordinate cluster to an HTTP client 410 depends on the geographic distance of the HTTP client from a subordinate cluster. In one embodiment, the left subordinate cluster managed by SCM 440 is relatively close to client 410, and the right subordinate cluster managed by SCM 450 is relatively distant. In this embodiment, the left subordinate cluster manifests lower latency for sending content to client 410 as compared to the right subordinate cluster. In one aspect, the lower latency is because information travels a shorter distance. In another aspect, the lower latency is because the left subordinate cluster has relatively more resources available for processing the request. Based on the left cluster having lower latency, DM 430 selects SCM 440 for servicing a GET request from HTTP client 410. Accordingly, DM 430 sends an HTTP message to HTTP client 410 for redirecting the GET request to the URL 1.domain.com of left SCM 440.

Responsive to receiving the redirection message from DM 430, HTTP client 410 sends a once redirected GET request to SCM 440. SCM 440 receives the once redirected GET request from client 410 and responsively selects a CS of the left cluster for servicing that GET request. In an aspect, SCM 440 selects CS 460, associated with the URL 1.1.domain.com of the left subordinate cluster, for the GET. The selection is based on a minimum latency forecast method. Accordingly, SCM 440 sends an HTTP message to HTTP client 410 for redirecting the GET request to CS 460 at the URL 1.1.domain.com. Client 410 receives the message for redirection from SCM 440 and responsively sends a twice redirected GET request to CS 460. CS 460 receives the twice redirected GET request from HTTP client 410 and responsively transmits the requested content to the HTTP client 410.

Although various methods for selecting a subordinate cluster have been described, the method for selecting a subordinate cluster for a GET request does not limit the scope or utility of cluster servers according to various aspects of the invention. In further embodiments, other methods and further combinations of methods are useful to select a subordinate cluster for servicing GET requests, depending on the application.

Some embodiments after FIG. 4 have alternative physical connection paths of a physical layer operable to support secure communications channels between various traffic managers (DM, SCMs) and servers (CSs, DSs). Furthermore, the alternative connection paths are often redundant. For example, in FIG. 4 it can be seen that there are two different physical paths from CS 460 to SCM 440. One path includes connection 463, network 420 and connection 443. Another redundant path is by way of connection 444.

There are also redundant physical paths between CS 480 and SCM 450. One path includes connection 451, network 420 and connection 433, and a second path is by way of physical connection 457. As well, it can be seen that there are redundant physical paths between CS 470 and SCM 440. One path is by way of connection 464, network 420 and connection 443, and a second path is by way of physical connection 446.

In a physical layer, CS 460 has connection 444 with SCM 440, connection 465 with DS 490, and connection 463 with network 420. DS 490 also has connection 445 with SCM 440, connection 475 with CS 470, and connection 492 with network 499. Also, CS 470 has connection 464 with network 420, and connection 446 with DM 430. Furthermore DM 430 has connection 433 with network 420 and connection 435 with network 499.

In some embodiments, network 499 is joined to network 420. It will be apparent that the joining forms further redundant physical connection paths in these embodiments. For example, in one of these embodiments CS 470 is connected by way of connection 464 to portion 420 of joined network 420/499 and thence through to DS 490 and DS 495 by way of connections 492 and 497 respectively. Hence in these embodiments CS 470 has one physical connection path to DS 490 by way of connection 475, and a different physical connection path to DS 490 by way of connection 464, the joined network 420/499, and connection 492. Various other redundant connection paths formed through the joining of network 420 with 499 will be apparent from the figure.

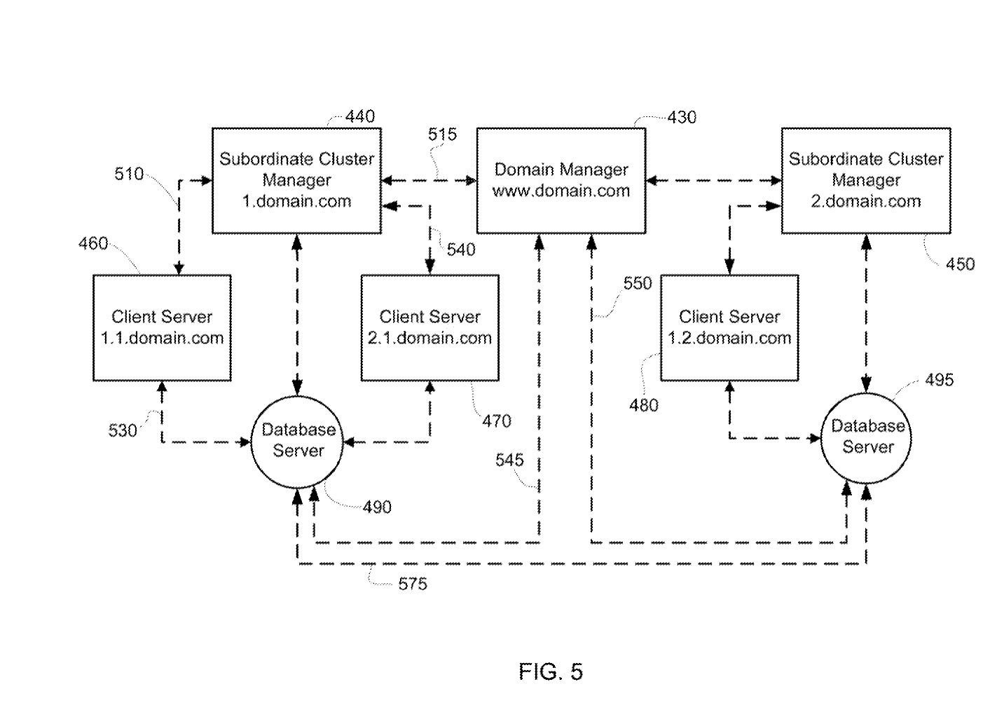

In embodiments, information is often sent between the various units of the cluster server by way of secure communications channels. An embodiment after FIG. 4 comprises the secure communications channels shown as dashed lines in FIG. 5. As pointed out above, a secure communications channel between one physical unit and another is over at least one physical path for carrying signals between the units in a physical layer. In various embodiments, secure communications channels are sometimes carried over a plurality of physical connection paths. In many of these embodiments, an operable secure communications channel is maintained during physical path failure (e.g. hardware malfunction, signal interference, disconnection, etc.) when at least one alternative physical signal path remains operable. Hence a plurality of redundant physical signal paths often enhances reliability. Furthermore, a secure communications channel over multiple paths often provides greater bandwidth, because information is operable to be transmitted in parallel.

In various embodiments, a secure communications channel is secure from eavesdropping by way of encryption such as RSA encryption, PGP encryption, secret key encryption and others. In further embodiments, a secure communications channel is secure from eavesdropping by way of having its physical carrier signals confined to be exclusively within secured locations. A secure communications channel with no encryption is preferable in some applications because encryption often requires considerable resources for processing. Hence encryption increases cost and/or reduces data throughput in some embodiments.

Various exemplary secure communications channel relating to a cluster server embodiment in FIG. 4 and FIG. 5 are now discussed. The same numerals are used to reference like objects in these figures. The dotted lines in FIG. 5 represent secure communications channels among the DM, SCCs, CSs and DSs of FIGS. 4 and 5. In the following, numerals within the range 500 to 599 designate some of the secure communications channels shown by the dotted lines in FIG. 5.

In one embodiment, network 420 is effectively a portion of the internet and client 410 is an internet client (FIG. 4). Since network 420 is a public network, information in secure communications channels is encrypted over network 420. For example, CS 470 has a secure communications channel 540 with SCM 440 in the embodiment. The secure communications channel 540 is carried over a physical layer that includes one physical signal path by way of physical connection 446, and another physical signal path by way of physical connection 464, network 420 and physical connection 443 of FIG. 4. Information in secure communications channel 540 is encrypted over network 420. Similarly, secure communications channel 510 of CS 460 with SCM 440, is implemented over a physical layer that includes one physical signal path traversing physical connection 444, and a redundant second physical signal path traversing connection 463, network 420 and connection 443. The information in secure communications channel 510 is encrypted over network 420. Various other secure communications channels, and alternate physical paths that are operable to carry some secure communications channels will be apparent from FIG. 4 and FIG. 5. In some embodiments all portions of some secure communication channels are encrypted, inclusive of those portions traversing physical carrier signals within secured locations. In some alternate embodiments all portions of all secure communications channel are encrypted.

In various embodiments, the left subordinate cluster is geographically distant from the right subordinate cluster. In these embodiments, secure communications channel 575 for sending information between database server units 490 and 495, is operable to maintain a database mirror in each of the subordinate clusters. It is often impractical and/or uneconomic to obtain a physically secure long distance signal carrier network 499. Hence the secure communications channel 575 is often implemented with an encrypted protocol carried over an insecure physical network 499 in these embodiments.

In some embodiments database mirroring between DS 490 and DS 495 is implemented by way of secure communications channels 545 and 550 of each DS with DM 430. DM 430 receives information comprising changed records of each DS by way of the respective secure communications channels 545 and 550, and sends changes occurring in one DS to the other DS for synchronizing. In the embodiment the subordinate clusters and the DM are widely separated from each other, and network 499 is insecure (e.g. subject to eavesdropping). Secure communication channel 545 between DS 490 and DM 430, and secure communications channel 550 between DS 495 and DM 430 are maintained with an encrypted protocol. There is an aspect where each of these secure communications channels is in a virtual private network. In a further embodiment, a database mirrored in DS 490 and DS 495 is synchronized by means of direct communications of these DSs with each other, using secure communications channel 575. In yet other embodiments, DS 490 and DS 495 are synchronized to each other using direct communications between DS 490 and DS 495, as well as communications that are mediated with DM 430. Furthermore, in some embodiments, redundant synchronization information is sent over alternative paths and channels to improve reliability (e.g. via secure communications channels 545 and 550 of the DSs with DM 430, and via secure communications channel 575). Methods of mirroring and/or synchronizing databases do not limit the scope of the claims. Those of ordinary skill in the art will recognize further methods for mirroring and/or synchronizing a database will be useful, depending on the embodiment.

In another cluster server embodiment according to FIG. 4, DM 430 receives a GET request from an HTTP client 410 and selects the right subordinate cluster for servicing the GET request. DM 430 sends a message to the HTTP client for redirecting the GET request to SCM 450 of the right subordinate cluster. In various aspects, selecting a subordinate cluster depends on round robin, geographical client location, resource availability and/or other parameters.

In further cluster server embodiments, various other configurations are implemented. For example, there are embodiments having a DM and a plurality of more than two subordinate clusters. In one of these embodiments, each subordinate cluster has one SCM operable to receive HTTP information from HTTP clients coupled to a first network, and/or send HTTP messages to clients on that first network. In one aspect, the DM receives a GET request from an HTTP client by way of the first network. The DM selects a subordinate cluster for servicing the GET and redirects the GET request to the SCM of the selected subordinate cluster. The redirection is performed by sending a message to the HTTP for redirecting the GET request. The selection method is often based on round robin, geographical client location, resource availability and/or other factors. One of these further cluster server embodiments has a physical DM, two physical SCMs, nine physical CSs, and three physical DSs.

In a preferred embodiment of a cluster server, a third physical unit comprises a logical SCM and a logical CS. Furthermore, the cluster server has first and second subordinate clusters. The SCM of the first subordinate cluster is in that third physical unit comprising the SCM and a logical CM. In one aspect, the DM of the cluster server receives a GET request from an HTTP client and selects a subordinate cluster for servicing the GET request. The first subordinate cluster is selected based on round robin. The DM sends a message to the client for redirecting the GET request to the SCM of the selected first subordinate cluster in the third physical unit. That SCM receives the once redirected GET request from the HTTP client and, according to a round robin method, selects the CS module in the third physical unit for sending requested content to the HTTP client. Here the SCM in the third physical unit sends the once redirected GET request directly to the internal CS module by way of an internal communications channel in that third physical unit. The GET request is thereby sent directly from the SCM module to the selected CS in the same unit without any redirection. The selected CS module receives the GET request from the SCM module in its unit, and the CS module responsively sends the requested content to the HTTP client. In this aspect, sending the once redirected GET over the internal communications channel from the SCM to the internal CS provides relatively less physical network traffic and latency.

In a different embodiment, a physical unit of a subordinate cluster comprises an SCM and an internal CS. The DM of the cluster server receives a GET request from an HTTP client. The DM selects a subordinate cluster for servicing the GET and sends a message to the HTTP client for redirecting the GET to the SCM of the subordinate cluster. The SCM receives the once redirected GET request from the HTTP client and responsively selects a physical CS for the GET (e.g. the SCM is in a different physical unit from the selected CS). The SCM sends an HTTP message to the HTTP client for redirecting the GET request. The HTTP client receives the message and responsively sends a twice redirected GET request to the selected physical CS. The selected physical CS receives the twice redirected GET request and responsively sends the requested content to the HTTP client.

In further embodiments a cluster server has a plurality of subordinate clusters. The DM of the cluster server is geographically collocated with a first subordinate cluster. In a preferred embodiment, the DM, the SCM of the first subordinate cluster and a logical CM of that first subordinate cluster, are internal modules in one common physical unit. Hence the multimodule physical unit is operable to perform as the DM of the cluster server, as the SCM of the first subordinate clusters and as a CS of the first subordinate cluster. In one aspect, a client sends a GET request to a notorious URL of the domain. The URL is associated with the DM. The DM receives the GET request. Responsive to receiving the GET request, the DM selects the first subordinate cluster for servicing the GET request. To effectuate the selection, the DM sends the GET request directly to the SCM by way of an internal communications channel in the multimodule unit.

On receiving the GET request from the DM, the SCM selects the internal CM for servicing the GET. The SCM sends the GET request directly to the internal CS module by way of an internal communications channel in the common physical unit. Hence the GET request is sent from the DM to the selected SCM, and from the SCM to the selected CS, without redirection. Responsive to receiving the GET request from the SCM, the CS module sends the requested content to the HTTP client. In this aspect, sending the GET request internally from the DM to the SCM, and internally from the SCM to the CS, within the same multimodule physical unit, avoids network traffic and reduces latency.

There is a less preferred embodiment where the DM, the SCM of the first subordinate cluster and a logical CS of that first subordinate cluster, are internal modules in a common multimodule physical unit. In an aspect of this less preferred embodiment, a client sends a GET request to a notorious URL of the domain and the DM receives the GET request. As in the aforementioned preferred embodiment, the DM receives the GET request and selects the collocated subordinate cluster for servicing the GET. However, in the instant less preferred embodiment, the DM sends a first message to the client for redirecting the GET request to the SCM of the first subordinate cluster, that is in the physical unit of the DM. The GET is redirected to the SCM by way of the client, despite the SCM being internal in the common physical unit.

The client receives the first redirection message and responsively sends a once redirected GET request to the SCM. The SCM receives the once redirected GET request. The SCM selects the logical CS module in its physical unit to provide content for the GET. To effectuate the selection, the SCM sends a second message to the client to redirect the GET request to the logical CM in the SCM's physical unit. The GET is redirected to the CS by way of the client, despite the SCM and CS modules being in the same physical unit. The client receives the second message for redirecting the GET and responsively sends a twice redirected GET request to the CM. The CM receives the twice redirected GET request and responsively sends the requested content to the client.

The configurations and diagrams that have been presented are simplified to facilitate understanding. In the foregoing, the novel methods, systems and devices are described with reference to specific embodiments thereof, but those skilled in the art will recognize that the disclosures are not limited thereto. Various features and aspects of the above-described present methods, systems and devices may be used individually or jointly. Further, they can be utilized in any number of environments and applications beyond those described herein without departing from the broader spirit and scope of the specification. The specification and drawings are, accordingly, to be regarded as illustrative rather than restrictive. It will be recognized that the terms “comprising” “including,” and “having,” as used herein, are specifically intended to be read as open-ended terms of art.

Various aspects of the invention have been described herein in terms of preferred embodiments. However other embodiments, including alternatives, modifications, permutations and equivalents of the embodiments described herein, will be apparent to those skilled in the art from consideration of the specification, study of the drawings, and practice of the principles herein. The embodiments and preferred features described above should be considered exemplary, with the invention being defined by the appended claims, which therefore include all such alternatives, modifications, permutations and equivalents as fall within the true spirit and scope of the present invention.

What is claimed is:

1. A method for providing information to a clients the method comprising:
receiving a first request from the client, in a first manager of a cluster server;
selecting a first client server of the cluster server for the first request with no user interaction;
sending a first message to the client from the first manager, comprising redirection of the first request to the selected first client server;
receiving a redirected first request from the client in the selected first client server, and
sending a second message to the client from the selected first client server;
wherein the first request and the redirected first request each comprises a request for the information, the second message sent to the client is a message responsive to the redirected first request, and the cluster server comprises at least two or more client servers and one or more managers.

2. The method of claim 1 wherein the first request and the redirected first request are HTTP GET requests and the first and second messages are HTTP messages.

3. The method of claim 1 wherein the second message sent to the client comprises the information.

4. The method of claim 1 wherein the first manager is a domain manager or a subordinate cluster manager.

5. The method of claim 1 wherein selecting the first client server is based on a latency method.

6. The method of claim 1 wherein selecting the first client server is based on a round robin method.

7. The method of claim 1 wherein the redirection comprises a unique prefix to a URL of the domain.

8. The method of claim 1 further comprising:
obtaining first data from a database with a first database server, and
receiving the first data from the first database server in a first module;
wherein the cluster server further comprises the database and one or more database servers, the first database server is selected from among the one or more database servers and the first module is a manager or a client server of the cluster server.

9. The method of claim 8 further comprising:
sending second data relating to the client from a second module to a second database server,
storing the second data in the database with the second database server,
obtaining the second data from the database with the first database server, and
receiving the second data from the first database server in the first module;
wherein the second database server is selected from among any of the one or more database servers, and the second module is a manager or a client server of the cluster server.

10. The method of claim 9 wherein the second data comprises a session identification descriptor.

11. The method of claim 9 wherein obtaining the second data from the database depends on a session identification descriptor.

12. The method of claim 9 wherein the second module receives from the client at least a portion of the second data.

13. The method of claim 8 wherein:
a physical unit having no client server comprises the database, and
for each module of the two or more client servers and one or more managers, there is at least one database server from among the one or more database servers that is operable to communicate with the each module over a communications channel.

14. The method of claim 8 wherein none of the database servers are accessible to any unit outside of the cluster server.

15. The method of claim 1 wherein the cluster server further comprises at least first and second subordinate clusters having respective first and second subordinate cluster managers, and selecting the first client server comprises selecting a subordinate cluster manager from among the subordinate cluster managers of the cluster server.

16. The method of claim 15 wherein selecting the subordinate cluster manager depends on the geographic location of the client.

17. The method of claim 1 further comprising receiving another request from the client, in a domain manager of the cluster server, selecting a subordinate cluster manager of the cluster server for the other request with no user interaction, sending another message from the domain manager to the client comprising redirection of the other request to the selected subordinate cluster manager, and receiving a redirected other request from the client in the selected subordinate cluster manager; wherein the cluster server further comprises at least one subordinate cluster having one subordinate cluster manager.

18. The method of claim 17 wherein the first request from the client is the redirected other request received in the selected subordinate cluster manager, and the selected subordinate cluster manager is the first manager.

19. The method of claim 1 wherein:
the cluster server comprises at least first and second subordinate clusters and a database,
the first subordinate cluster comprises a first database server and the second subordinate cluster comprises a second database server,
the database is mirrored in at least the first and second database servers,
at least one module sends data relating to the clients to the first database server for storing in the database,
the first database server stores the data relating to the client in the database, and
another module receives the data relating to the client, from a database server selected from among the first and the second database servers; wherein the one module and the other module each is a manager or a client server of the cluster server.

20. The method of claim 1 wherein the cluster server further comprises at least one database server and a database, the database server obtains at least a portion of the information from the database, the selected client server receives that portion of the information from the database server, and the second message to the client comprises that portion of the information.

21. A cluster server comprising a traffic redirector, two or more client servers, a database, and one or more database servers, wherein:
the traffic redirector is operable to:
receive a first request for content from a client,
select a first client server from among the two or more client servers to send the content to the client, and
send a message to the client to redirect the first request for content to the selected first client server,
each of at least two client servers, from among the two or more client servers, is operable to send the content to the client responsive to receiving a redirected first request for content from the client, and
at least one database server from among the one or more database servers is operable to obtain at least a portion of the content from the data base and send that portion of the content to the selected client server.

22. The cluster server of claim 21 wherein:
the traffic director is operable to send first data to, and to receive second data from, a first database server selected from among all of the one or more database servers;
the first client server is operable to send second data to, and to receive first data from, a second database server selected from among all of the one or more database servers;
another client server selected from among all of the one or more client servers is operable to receive the first or the second data from a third database server selected from among all of the one or more database servers; and
the first or the second data, in single or in combination, relate to the client.

23. The cluster server of claim 21 wherein the first request for content and the redirected first request for content are HTTP GET requests, the message to the client to redirect the first request for content is an HTTP message, and each of the at least two client servers is operable to send the content to the client in an HTTP message.

24. Machine readable media comprising data and instructions operable for:
receiving a first request from a client in a manager of a cluster server,
selecting a client server of the cluster server for the first request, without user interaction,
sending a first message from the manager to the client for redirection of the first request to the selected client server,
receiving a redirected first request from the client in the selected client server, and
sending a second message to the client from the selected client server;
wherein the first request and the redirected first request each comprises a request for content, and the second message sent to the client comprises the content responsive to the redirected first request.

25. The machine readable media of claim 24 wherein the first request and the redirected first request are HTTP GET requests for the content and the first and the second messages to the client are HTTP messages.

26. The machine readable media of claim 24 further comprising data and instructions operable for:
sending data relating to the client from a first module in a first physical unit of the cluster server to a database server of the cluster server,
storing the data in a database with the database server, and
receiving the stored data from the database server in a second module of a second physical unit of the cluster server; wherein each of the first and second modules is a manager or client server.
